(19) United States
(12) Patent Application Publication
(10) Pub. No.: US 2026/0063509 A1
(43) Pub. Date: Mar. 5, 2026

(54) INSPECTION METHOD FOR OPTICAL FIBER RIBBON, INSPECTION DEVICE FOR OPTICAL FIBER RIBBON, AND MANUFACTURING METHOD FOR OPTICAL FIBER RIBBON

(71) Applicant: SUMITOMO ELECTRIC INDUSTRIES, LTD., Osaka (JP)

(72) Inventors: Itaru SAKABE, Osaka (JP); Hiroki ISHIKAWA, Osaka (JP); Kenji KAWAI, Osaka (JP); Kounan SHIN, Osaka (JP); Kouichi NAKASHIMA, Osaka (JP); Reo AMANO, Osaka (JP)

(21) Appl. No.: 19/309,920

(22) Filed: Aug. 26, 2025

(30) Foreign Application Priority Data
Aug. 28, 2024 (JP) 2024-146547

(51) Int. Cl. G01M 11/00; G02B 6/44

(52) U.S. Cl. CPC G01M 11/37; G02B 6/448

(57) ABSTRACT

An inspection method for an optical fiber ribbon in which a plurality of optical fibers are arranged in parallel and intermittently coupled in a longitudinal direction by a coupling resin. The inspection method includes emitting light toward the optical fiber ribbon that travels on a roller, from a direction along a tangent line of a surface of the roller with which the optical fiber ribbon comes into contact and parallel to a direction in which the optical fiber ribbon travels, to acquire an image in which the optical fiber ribbon is projected as a shadow, based on light that passed around the optical fiber ribbon, detecting an interval between the optical fibers, based on the image, and detecting a position of the coupling resin, based on the image.

### CROSS-REFERENCE TO RELATED APPLICATIONS

This application is based on and claims priority under 35 USC 119 from Japanese Patent Application No. 2024-146547 filed on Aug. 28, 2024, the entire content of which is incorporated herein by reference.

### TECHNICAL FIELD

The present disclosure relates to an inspection method for an optical fiber ribbon, an inspection device for an optical fiber ribbon, and a manufacturing method for an optical fiber ribbon.

### BACKGROUND ART

JP2017-125780A and JP2017-181513A disclose an inspection method for an optical fiber ribbon with fiber adhesive parts and non-adhesive parts, in which one surface of the optical fiber ribbon is irradiated with light, an image of the optical fiber ribbon is obtained by detecting illumination light (leakage light) passing through the fiber ribbon with a camera, and a coupling portion is inspected from the image. In this inspection method, the optical fiber ribbon is supported by a guide roller having a step portion, and a non-coupling portion is separated.

JP2012-042354A discloses an inspection method for an optical fiber ribbon with fiber adhesive parts and non-adhesive parts, in which an image of one surface of the optical fiber ribbon is obtained by a camera, and a length or the like of a non-coupling portion between coupling portions is measured from the image. In this inspection method, the optical fiber ribbon is supported by a guide roller having a step portion, and a non-coupling portion is separated.

JP2002-304922A discloses an inspection method for a flat cable, in which one surface of the flat cable is irradiated with light, and a transmission image of the flat cable obtained by the irradiation light is captured by a CCD camera to inspect a condition of a conductor and an insulating coating.

### SUMMARY OF INVENTION

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an inspection method for an optical fiber ribbon in which a plurality of optical fibers are arranged in parallel and intermittently coupled in a longitudinal direction by a coupling resin, the inspection method including:
emitting light toward the optical fiber ribbon that travels on a roller, from a direction along a tangent line of a surface of the roller with which the optical fiber ribbon comes into contact and parallel to a direction in which the optical fiber ribbon travels, to acquire an image in which the optical fiber ribbon is projected as a shadow, based on light that passed around the optical fiber ribbon;
detecting an interval between the optical fibers, based on the image; and
detecting a position of the coupling resin, based on the image.

### BRIEF DESCRIPTION OF DRAWINGS

Exemplary embodiment(s) of the present invention will be described in detail based on the following figures, wherein:

FIG. 1 is a diagram illustrating a configuration of an inspection device for an optical fiber ribbon according to the present embodiment;

FIG. 2 is a plan view illustrating a configuration of the optical fiber ribbon;

FIG. 3 is a cross-sectional view illustrating a configuration of a cross section taken along a line III-III in FIG. 2 as viewed from a direction indicated by an arrow;

FIG. 4 is a cross-sectional view illustrating a configuration of a cross section taken along a line IV-IV in FIG. 2 as viewed from a direction indicated by an arrow;

FIG. 5 is a schematic diagram illustrating a configuration of a manufacturing device for an optical fiber ribbon incorporating the inspection device;

FIG. 6 is a cross-sectional view illustrating a configuration of a cross section taken along a line VI-VI in FIG. 1 as viewed from a direction indicated by an arrow;

FIG. 7 is a flowchart illustrating an inspection method for an optical fiber ribbon; and

FIG. 8 is a view illustrating an image of an optical fiber ribbon.

### DESCRIPTION OF EMBODIMENTS

When the optical fiber ribbon with fiber adhesive parts and non-adhesive parts is inspected using transmitted light, it is difficult to acquire an image with high contrast in which a coupling resin can be identified since the coupling resin is transparent and light is easily transmitted. In addition, when the non-coupling portion is separated using a guide roller so as to make it easier to obtain an image of the non-coupling portion, unless there is a reliable gap in the optical fiber at the non-coupling portion, it is difficult to detect the non-coupling portion from the image. In particular, when the traveling speed of the optical fiber ribbon increases, the optical fiber ribbon may vibrate and lift off from the guide roller, resulting in the occurrence of locations where a step or protrusion becomes ineffective.

The present disclosure provides an inspection method, an inspection device, and a manufacturing method for an optical fiber ribbon that can accurately detect a position of a coupling resin.

According to the present disclosure, it is possible to provide an inspection method, an inspection device, and a manufacturing method for an optical fiber ribbon that can accurately detect a position of a coupling resin.

### DESCRIPTION OF EMBODIMENTS OF PRESENT DISCLOSURE

First, an embodiment of the present disclosure will be listed and described.

(1) An inspection method for an optical fiber ribbon according to the present disclosure is an inspection method for an optical fiber ribbon in which a plurality of optical fibers are arranged in parallel and intermittently coupled in a longitudinal direction by a coupling resin. The inspection method includes: emitting light, toward the optical fiber ribbon that travels on a roller, from a direction along a tangent line of a surface of the roller with which the optical fiber ribbon comes into contact and parallel to a direction in which the optical fiber ribbon travels, to acquire an image in which the optical fiber ribbon is projected as a shadow, based on light that passed around the optical fiber ribbon; detecting an interval between the optical fibers, based on the image; and detecting a position of the coupling resin, based on the image.

According to the above method, light is emitted from the direction parallel to the direction in which the optical fiber ribbon travels and along the tangent line of the surface of the roller with which the optical fiber ribbon comes into contact. Therefore, light incident on the optical fiber ribbon is reflected by surfaces of the optical fiber and the coupling resin, and is refracted within the optical fiber and the coupling resin. As a result, a portion corresponding to the optical fiber and the coupling resin in the image becomes a shadow, and the position of the coupling resin can be accurately detected from the image.

(2) The inspection method for an optical fiber ribbon according to the above (1) may further include: determining whether the interval between the optical fibers is within a predetermined range; determining whether the position of the coupling resin is at a predetermined position; and outputting a determination result of the interval between the optical fibers and the position of the coupling resin.

According to such a method, the positions of the optical fibers and the coupling resin can be accurately detected, so that it is possible to accurately determine whether the interval between the optical fibers is within the predetermined range and the position of the coupling resin is at the predetermined position.

(3) In the inspection method according to the above (1) or (2), the roller may have a drum shape with a bulging center.

When the interval in the longitudinal direction between the coupling resins is long, the interval in the arrangement direction between the optical fibers traveling on the drum-shaped roller with a bulging center tends to become wider. Therefore, it is possible to determine whether the coupling resin is applied at the predetermined position based on the interval in the arrangement direction of the optical fibers in the image.

(4) In the inspection method according to any one of the above (1) to (3), the coupling resin is applied to a first surface of the optical fiber ribbon, and the optical fiber ribbon is conveyed such that a second surface of the optical fiber ribbon comes into contact with the surface of the roller, the second surface being opposite to the first surface on which the coupling resin is applied.

According to such a method, a portion where the coupling resin is projected is farther away than a portion where the roller is projected in the image, so that the position of the coupling resin can be easily determined.

(5) In the inspection method according to any one of the above (1) to (4), in the detecting the interval between the optical fibers, apexes of portions corresponding to the optical fibers may be detected in the image to measure an interval between adjacent apexes.

The optical fiber has a circular cross section, and an interval between the apexes of adjacent optical fibers can be regarded as the interval between the adjacent optical fibers. Therefore, the interval between the optical fibers can be detected by measuring the interval between the apexes of the portions corresponding to the optical fibers in the image.

(6) An inspection device for an optical fiber ribbon according to the present disclosure is an inspection device for an optical fiber ribbon in which a plurality of optical fibers are arranged in parallel and intermittently coupled in a longitudinal direction by a coupling resin. The inspection device includes: a light source configured to emit light, toward the optical fiber ribbon that travels on a roller, from a direction along a tangent line of a surface of the roller with which the optical fiber ribbon comes into contact and parallel to a direction in which the optical fiber ribbon travels; an imaging device configured to acquire an image in which the optical fiber ribbon is projected as a shadow, based on light that passed around the optical fiber ribbon; and a controller configured to detect an interval between the optical fibers and a position of the coupling resin, based on the image.

According to such a configuration, light is emitted from the direction parallel to the direction in which the optical fiber ribbon travels and along the tangent line of the surface of the roller with which the optical fiber ribbon comes into contact. Therefore, light incident on the optical fiber ribbon is reflected by surfaces of the optical fiber and the coupling resin, and is refracted within the optical fiber and the coupling resin. As a result, a portion corresponding to the optical fiber and the coupling resin in the image based on transmitted light becomes a shadow, and the position of the coupling resin can be accurately detected from the image.

(7) In the inspection device according to the above (6), the controller may be configured to determine whether the interval between the optical fibers is within a predetermined range and whether the position of the coupling resin is at a predetermined position, and output a determination result of the interval between the optical fibers and the position of the coupling resin.

According to such a configuration, the positions of the optical fibers and the coupling resin can be accurately detected, so that it is possible to accurately determine whether the interval between the optical fibers is within the predetermined range and the position of the coupling resin is at the predetermined position.

(8) A manufacturing method for an optical fiber ribbon according to the present disclosure is a manufacturing method for an optical fiber ribbon in which a plurality of optical fibers are arranged in parallel and intermittently coupled in a longitudinal direction by a coupling resin. The manufacturing method includes: emitting light, toward the optical fiber ribbon that travels on a roller, from a direction along a tangent line of a surface of the roller with which the optical fiber ribbon comes into contact and parallel to a direction in which the optical fiber ribbon travels, to acquire an image in which the optical fiber ribbon is projected as a shadow, based on light that passed around the optical fiber ribbon; detecting an interval between the optical fibers, based on the image; detecting a position of the coupling resin, based on the image; determining whether the interval between the optical fibers is within a predetermined range; determining whether the position of the coupling resin is at a predetermined position; outputting a determination result of the interval between the optical fibers and the position of the coupling resin; and determining quality of the optical fiber ribbon, using the determination result.

According to such a method, the quality of the optical fiber ribbon can be accurately determined in a manufacturing process of the optical fiber ribbon.

### DETAILS OF EMBODIMENTS OF PRESENT DISCLOSURE

Specific examples of an inspection method, an inspection device, and a manufacturing method for an optical fiber ribbon according to the present disclosure will be described with reference to the drawings. However, the present invention is not limited to these examples, but is defined by the claims, and is intended to include all modifications within the meaning and scope of the claims.

### (Inspection Device for Optical Fiber Ribbon)

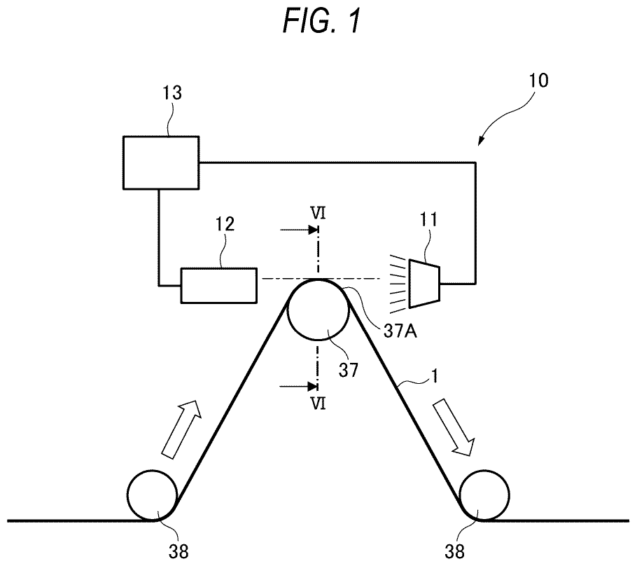

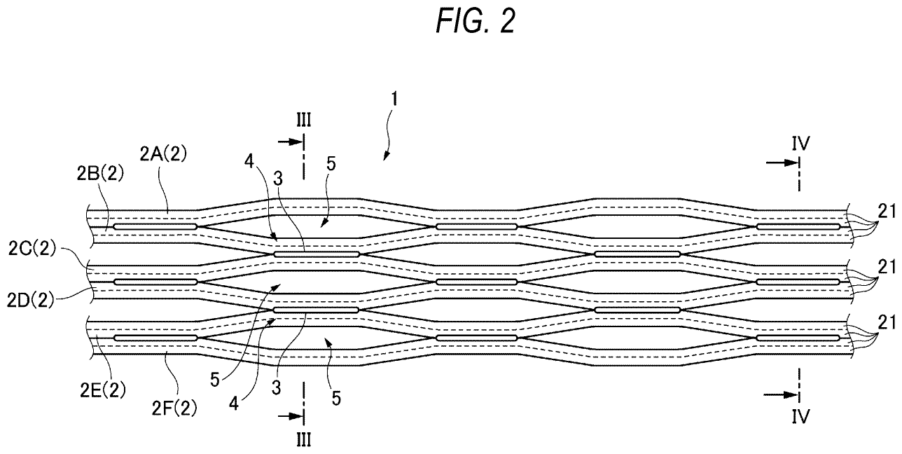

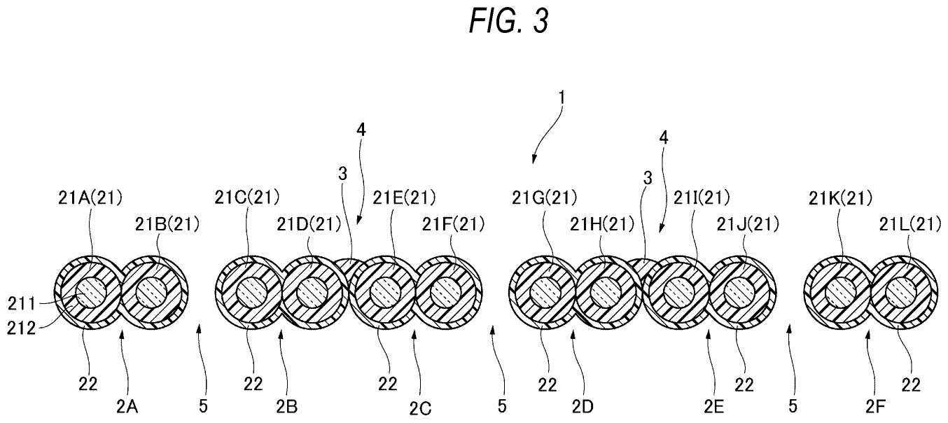

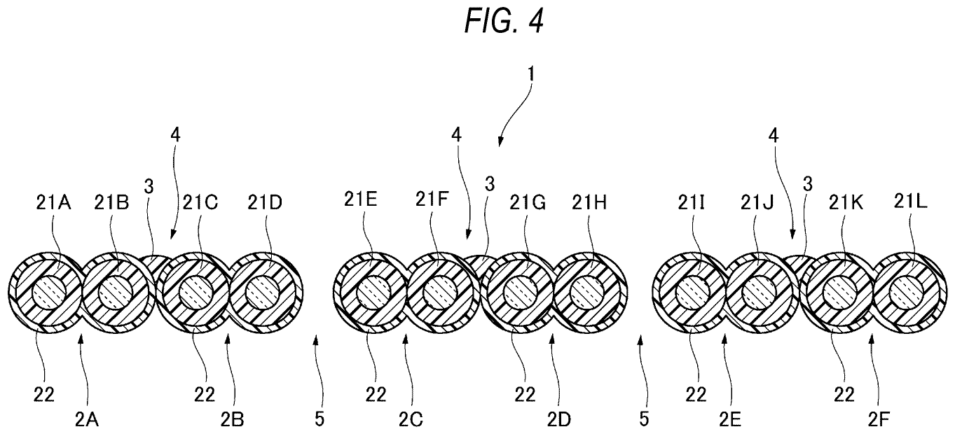

FIG. 1 is a diagram showing a configuration of an inspection device 10 for an optical fiber ribbon 1 according to the present embodiment. FIG. 2 shows an example of the optical fiber ribbon 1. FIG. 2 shows the optical fiber ribbon 1 in a state in which a non-coupling portion 5 is expanded in an arrangement direction of optical fibers 21. FIGS. 3 and 4 show shapes of cross sections of the optical fiber ribbon 1 of FIG. 2. In FIG. 1, arrows indicate a traveling direction of the optical fiber ribbon 1.

As illustrated in FIG. 2, the optical fiber ribbon 1 includes a plurality of optical fibers 21 arranged in parallel and intermittently coupled in a longitudinal direction by coupling resins 3. In this example, the optical fiber ribbon 1 has twelve optical fibers 21. As illustrated in FIG. 3, each of the optical fibers 21 includes a glass fiber 211 and a coating layer 212. The glass fiber 211 includes, for example, a core and a cladding. The coating layer 212 coats the periphery of the glass fiber 211. The coating layer 212 includes one or more coating layers. The coating layer 212 may include a colored layer that is colored in a predetermined color as the outermost layer.

Two adjacent optical fibers 21 are integrated by a coating resin 22 in a state of being continuously in contact with each other in the longitudinal direction to form a sub-ribbon 2. The coating resin 22 coats the periphery of the two adjacent optical fibers 21 in the longitudinal direction. The coating resin 22 is formed of a resin material such as an acrylic ultraviolet curable resin or an epoxy ultraviolet curable resin. The coating resin 22 is, for example, a transparent resin.

In this example, as illustrated in FIGS. 3 and 4, the optical fiber ribbon 1 includes twelve optical fibers 21A to 21L, and two adjacent optical fibers 21 (21A and 21B, 21C and 21D, 21E and 21F, 21G and 21H, 21I and 21J, 21K and 21L) form sub-ribbons (2A, 2B, 2C, 2D, 2E, 2F).

As illustrated in FIG. 2, the plurality of sub-ribbons 2 are arranged in parallel and intermittently coupled to each other in the longitudinal direction by the coupling resins 3. Accordingly, in the optical fiber ribbon 1, a coupling portion 4 where two adjacent sub-ribbons 2 are coupled to each other by the coupling resin 3 and the non-coupling portion 5 where the adjacent sub-ribbons 2 are not coupled to each other are intermittently provided in the longitudinal direction. The coupling resin 3 is formed of a resin material such as an acrylic ultraviolet curable resin or an epoxy ultraviolet curable resin. The coupling resin 3 is, for example, a transparent resin. The coupling resin 3 may be formed of the same resin material as the coating resin 22.

The inspection device 10 is configured to inspect whether an interval between the optical fibers 21 in the arrangement direction of the optical fibers 21 forming the optical fiber ribbon 1 and the position of the coupling resin 3 are normal. For example, the inspection of the optical fiber ribbon 1 by the inspection device 10 is performed during a manufacturing process of the optical fiber ribbon 1, and the optical fiber ribbon 1 is manufactured while determining the quality of the optical fiber ribbon 1.

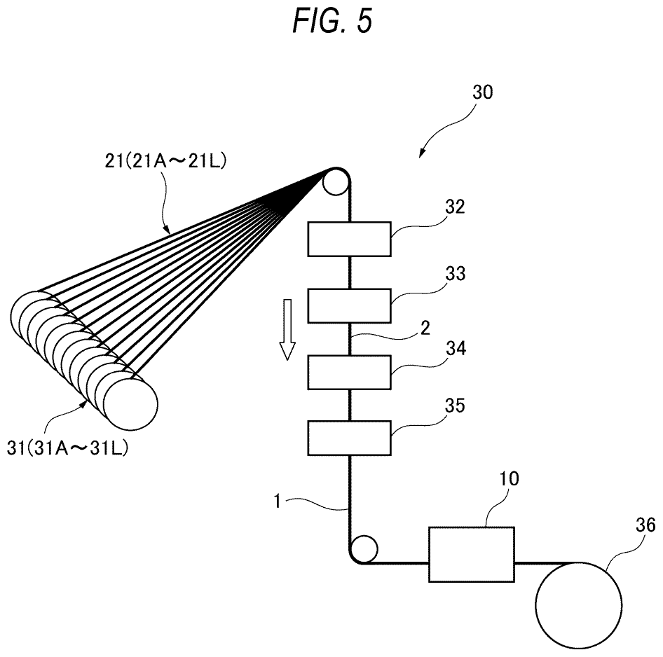

FIG. 5 shows a configuration of a manufacturing device 30 for the optical fiber ribbon 1, in which the inspection device 10 is incorporated. The inspection device 10 is configured to inspect the optical fiber ribbon 1 formed by the manufacturing device 30. In FIG. 5, the arrow indicates a traveling direction of the optical fiber 21.

As illustrated in FIG. 5, the manufacturing device 30 includes a supply bobbin 31, a first coating device 32, a first curing device 33, a second coating device 34, a second curing device 35, and a winder 36.

The optical fibers 21A to 21L wound around supply bobbins 31A to 31L are unwound and conveyed to the first coating device 32. In the first coating device 32, the coating resin 22 is applied around every two adjacent optical fibers 21 among the plurality of optical fibers 21A to 21L. The coating resin 22 applied around the optical fibers 21 is cured in the first curing device 33 by, for example, irradiating with ultraviolet light. Accordingly, the plurality of sub-ribbons 2 in which two optical fibers 21 are integrated with the coating resin 22 are formed.

Subsequently, the plurality of sub-ribbons 2 are conveyed to the second coating device 34 in a state of being arranged in parallel. In the second coating device 34, the coupling resin 3 is applied between adjacent sub-ribbons 2. The coupling resins 3 applied between the adjacent sub-ribbons 2 are cured in the second curing device 35 by, for example, irradiating with ultraviolet light. Accordingly, the optical fiber ribbon 1, in which the plurality of sub-ribbons 2 are intermittently coupled to each other by the coupling resins 3 in the longitudinal direction, is formed.

In the present example, the optical fibers 21A to 21L that are unwound from the supply bobbins 31A to 31L are rotated by an upper roller and then travel downward to form the optical fiber ribbon 1 in which the optical fibers 21A to 21L are arranged side by side in a direction orthogonal to the paper surface of FIG. 5.

The optical fiber ribbon 1 is wound by the winder 36. The operation of each device is controlled by an intermittent coating controller (not shown).

The inspection device 10 is disposed on a path line of the optical fiber ribbon 1 between the second curing device 35 and the winder 36, and inspects the traveling optical fiber ribbon 1.

Specifically, as illustrated in FIG. 1, the inspection device 10 includes a light source 11, an imaging device 12, and a camera controller 13. The camera controller 13 corresponds to a controller in the present disclosure.

The light source 11 and the imaging device 12 are disposed to face each other with a roller 37 interposed therebetween. The roller 37 is disposed on the path line of the optical fiber ribbon 1 so as to change the traveling direction of the optical fiber ribbon 1 while guiding the optical fiber ribbon 1. In the present example, the traveling direction of the optical fiber ribbon 1 is changed from obliquely upward to obliquely downward by the roller 37.

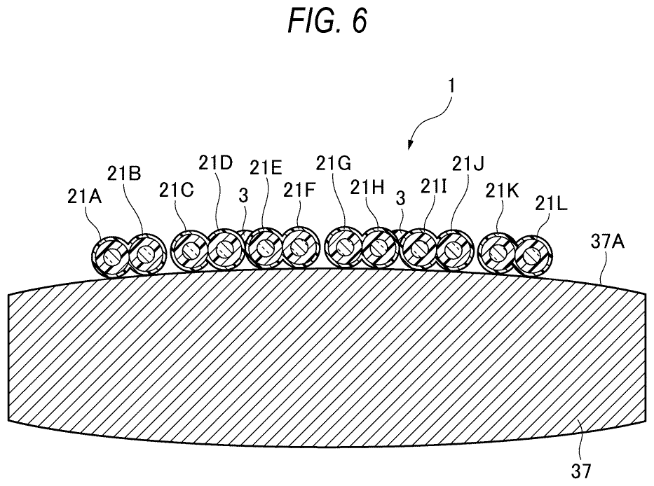

FIG. 6 is a cross-sectional view illustrating a configuration of a cross section taken along a line VI-VI in FIG. 1 as viewed from a direction indicated by an arrow. The roller 37 has, for example, a drum shape with a bulging center. As illustrated in FIG. 6, a side surface 37A of the roller 37 is formed in an arc shape in a cross section orthogonal to the traveling direction of the optical fiber ribbon 1. For example, the roller 37 is formed such that the radius of curvature of the side surface 37A in the cross section is 50 mm.

The optical fiber ribbon 1 travels on the side surface 37A of the rotating roller 37. As illustrated in FIG. 6, the optical fiber ribbon 1 travels on the roller 37 in a state where the plurality of optical fibers 21 are arranged in an arc shape along the side surface 37A of the roller 37. For example, the optical fiber ribbon 1 is conveyed such that the coupling resin 3 is applied to only one surface of the optical fiber ribbon 1 and a surface opposite to the surface on which the coupling resin 3 is applied is in contact with the side surface 37A of the roller 37.

As illustrated in FIG. 1, the light source 11 is configured to emit light toward the optical fiber ribbon 1 traveling on the roller 37. The light source 11 is configured to emit, for example, white light.

The light source 11 is configured to emit light toward the optical fiber ribbon 1 traveling on the roller 37 from a direction along a tangent line to the side surface 37A of the roller 37 and parallel to a direction in which the optical fiber ribbon 1 travels. The side surface 37A corresponds to a surface of a roller with which the optical fiber ribbon 1 comes into contact of the present disclosure.

In this example, the optical fiber ribbon 1 is in contact with a region over a range of about 120 degrees on the side surface 37A of the roller 37 when viewed from the arrangement direction of the optical fibers 21 (direction perpendicular to the paper surface of FIG. 1). The light source 11 emits light toward the optical fiber ribbon 1 from a direction along a tangent line (one-dot chain line in FIG. 1) drawn from a point located at the uppermost position in the region.

In other words, the light source 11 is configured to emit light, in the traveling direction of the optical fiber ribbon 1 or in a direction opposite to the traveling direction, toward the optical fiber ribbon 1 traveling on the side surface 37A of the roller 37. In the present example, the light source 11 is configured to emit light in the direction (left direction in FIG. 1) opposite to the traveling direction of the optical fiber ribbon 1.

In this specification, a predetermined direction is not limited to a direction exact the same as the predetermined direction, and a slight deviation is allowed.

The imaging device 12 is disposed to face the light source 11 with the roller 37 interposed therebetween. The imaging device 12 is configured to acquire an image in which the optical fiber ribbon 1 is captured. The image is based on light that has passed around the optical fiber ribbon 1, and the optical fiber ribbon 1 is projected as a shadow. The imaging device 12 is, for example, a CMOS camera.

The camera controller 13 is, for example, a general-purpose computer including a general-purpose memory and a general-purpose microprocessor that operates in cooperation with the general-purpose memory. The camera controller 13 is configured to control operations of the light source 11 and the imaging device 12. Specifically, the camera controller 13 is configured to output, to the imaging device 12 and the light source 11, a control signal for controlling an imaging interval of the imaging device 12 and an exposure time of the light source 11. For example, the camera controller 13 is configured to control the operations of the imaging device 12 and the light source 11 such that a length over which the optical fiber ribbon 1 travels during exposure (that is, the measurement deviation amount) is 3 mm or less. When a length over which the coupling resin is applied is 30 mm, the measurement error in the longitudinal direction can be reduced to 10% or less as long as the measurement deviation amount is 3 mm or less.

The camera controller 13 is configured to acquire data on the image in which the optical fiber ribbon 1 is captured as a shadow from the imaging device 12, and to detect an interval between the optical fibers 21 and the position of the coupling resin 3 based on the acquired image. Then, the camera controller 13 is configured to determine whether the detected interval between the optical fibers 21 and the position of the coupling resin 3 are normal.

The camera controller 13 outputs a determination result for the interval between the optical fibers 21 and the position of the coupling resin 3. The determination result output from the camera controller 13 is output to, for example, a display device and a storage device (not illustrated), displayed on the display device, and stored in the storage device.

### (Inspection Method for Optical Fiber Ribbon)

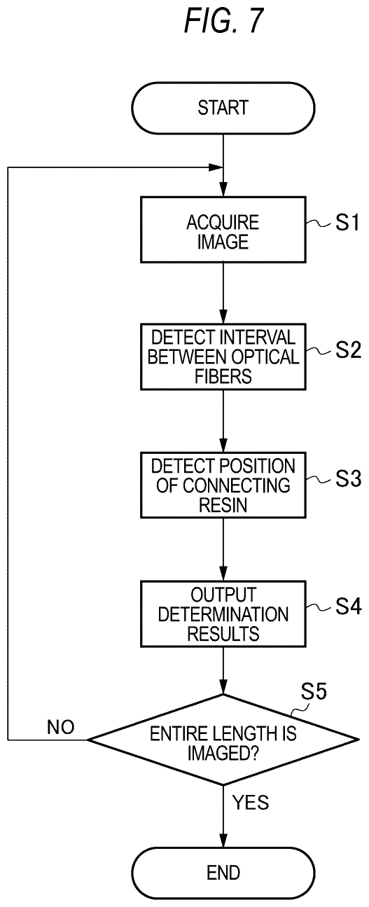

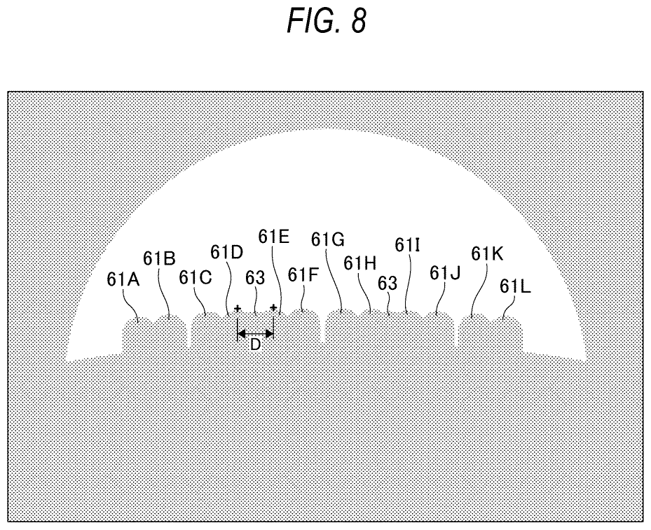

Next, an inspection method for the optical fiber ribbon 1 using the inspection device 10 will be described with reference to FIGS. 7 and 8. FIG. 7 is a flowchart illustrating the inspection method for the optical fiber ribbon 1.

First, the optical fiber ribbon 1 traveling on the roller 37 is irradiated with light by the light source 11 from a direction parallel to the direction in which the optical fiber ribbon 1 travels and along the tangent line of the side surface 37A of the roller 37 with which the optical fiber ribbon 1 comes into contact, and an image in which the optical fiber ribbon 1 is captured as a shadow is acquired by the imaging device 12 (S1).

Subsequently, the camera controller 13 detects an interval between the optical fibers 21, based on the image of the optical fiber ribbon 1 acquired from the imaging device 12 (S2).

Subsequently, the camera controller 13 detects the position of the coupling resin 3, based on the image of the optical fiber ribbon 1 acquired from the imaging device 12 (S3).

FIG. 8 illustrates an image of the optical fiber ribbon 1 acquired by the imaging device 12. FIG. 8 is an image of the optical fiber ribbon 1 in which the coupling resin 3 is located between the optical fiber 21D and the optical fiber 21E and between the optical fiber 21H and the optical fiber 211 as illustrated in FIG. 6.

In the image shown in FIG. 8, a white semicircular portion is light emitted from the light source 11 and passing around the optical fiber ribbon 1. The light emitted from the light source 11 and emitted to the roller 37 is blocked by the roller 37, and a portion corresponding to the roller 37 is projected as a shadow.

The light emitted from the light source 11 and incident on the optical fiber ribbon 1 is reflected by surfaces of the optical fiber 21 and the coupling resin 3, and is refracted within the optical fiber 21 and the coupling resin 3. Thus, in the image shown in FIG. 8, a portion corresponding to the optical fiber ribbon 1 is projected as a shadow.

The camera controller 13 is configured to detect the interval between the optical fibers 21 and the position of the coupling resin 3 from the shadow corresponding to the optical fiber ribbon 1 based on the image shown in FIG. 8.

Specifically, as illustrated in FIG. 3, the optical fiber 21 has a circular cross section, and an interval between the apexes of adjacent optical fibers 21 can be regarded as the interval between the adjacent optical fibers 21. The apex of the optical fiber 21 is a point at which a thickness of the optical fiber 21 is maximum in a thickness direction (a direction orthogonal to the longitudinal direction and the arrangement direction) of the optical fiber ribbon 1, and is a point at which a virtual line extending from the center of the optical fiber 21 in the thickness direction intersects an outer periphery of the optical fiber 21.

The camera controller 13 is configured to measure an interval D between the apexes of adjacent shadows in shadows 61A to 61L of the optical fibers 21A to 21L in the image illustrated in FIG. 8. The apex of the shadow corresponding to the optical fiber 21 is the highest point in the shadow corresponding to the optical fiber 21. For example, in FIG. 8, the apexes of the shadows 61D and 61E corresponding to the optical fibers 21D and 21E are indicated by plus (+) marks.

The camera controller 13 is configured to detect, as the interval between the corresponding optical fibers 21, the measured interval D between the apexes of the shadows corresponding to the optical fibers 21.

As illustrated in FIG. 3, the coupling resin 3 is provided in a recessed portion between the optical fibers 21 of adjacent sub-ribbons 2. That is, the recessed portion between the optical fibers 21 of adjacent sub-ribbons 2 where the coupling resin 3 is provided is raised higher than a recessed portion between adjacent optical fibers where the coupling resin 3 is not provided.

The camera controller 13 is configured to determine that a shadow 63 in which a recessed portion between adjacent shadows in the shadows 61A to 61L of the optical fibers 21A to 21L is raised higher than a recessed portion between other adjacent shadows is a portion where the coupling resin 3 is provided in the image illustrated in FIG. 8. In the present example, the recessed portions between the adjacent shadows 61D and 61E and between the adjacent shadows 61H and 611 are raised higher than the recessed portions between other adjacent shadows. The camera controller 13 is configured to determine that the coupling resin 3 is provided between the optical fibers 21D and 21E corresponding to the shadows 61D and 61E and between the optical fibers 21H and 21I corresponding to the shadows 61H and 61I.

Returning to FIG. 7, when the interval between the optical fibers 21 and the position of the coupling resin 3 are detected, the camera controller 13 determines whether the detected interval between the optical fibers 21 and the position of the coupling resin 3 are normal. Then, determination results of the interval between the optical fibers 21 and the position of the coupling resin 3 are output to a display device or a storage device (S4).

Specifically, it is determined whether the interval between the optical fibers 21 is within a predetermined range. Further, it is determined whether the position of the coupling resin 3 is located at a predetermined position, for example, between specific optical fibers 21 among the plurality of optical fibers 21 forming the optical fiber ribbon 1. The predetermined range and the predetermined position are appropriately set within a range in which the size of the optical fiber 21, the arrangement of the set coupling resin 3, and the errors in size and shape are acceptable, for example.

The determination result includes, for example, an image of the optical fiber ribbon 1 including the optical fibers 21 and the coupling resins 3 determined to be abnormal, position information of the optical fiber 21 and the coupling resin 3 determined to be abnormal in the longitudinal direction of the optical fiber ribbon 1, and the like.

The processes of S1 to S4 are repeated until the entire length of the optical fiber ribbon 1 is imaged (NO in S5). On the other hand, when the entire length of the optical fiber ribbon 1 is imaged (YES in S5), the process ends.

Incidentally, for example, when light is emitted onto one surface of the optical fiber ribbon 1 (the surface along the longitudinal direction and the arrangement direction of the optical fibers) and an image is acquired based on the light transmitted through the optical fiber ribbon, since the transparent coupling resin easily transmits the light, the coupling resin is hardly projected in the image, making it difficult to distinguish the coupling resin from the image.

However, according to the inspection device 10, the inspection method, and the manufacturing method for the optical fiber ribbon 1 of the present embodiment, light is emitted from the direction along the tangent line of the side surface 37A of the roller 37, so that light incident on the optical fiber ribbon 1 is reflected by the surfaces of the optical fiber 21 and the coupling resin 3, and is refracted within the optical fiber 21 and the coupling resin 3. As a result, a portion corresponding to the optical fiber 21 and the coupling resin 3 in the image acquired by the imaging device 12 becomes a shadow, and the position of the coupling resin 3 can be accurately detected from the image.

Although the present invention is described in detail and with reference to specific embodiment, it will be apparent to those skilled in the art that various changes and modifications can be made therein without departing from the spirit and scope of the present invention. In addition, the number, positions, shapes, and the like of members described above are not limited to those in the above-described embodiments, and can be changed to the number, positions, shapes, and the like suitable for carrying out the present invention.

In the above embodiment, the camera controller 13 may determine whether the coupling resin 3 is provided at the predetermined position based on the interval between adjacent optical fibers 21. For example, as illustrated in FIG. 6, in a case where the optical fiber ribbon 1 travels on the drum-shaped roller 37 having a bulging central, when the interval in the longitudinal direction between the coupling resins 3 is long, the interval in the arrangement direction between the optical fibers 21 traveling on the roller 37 side by side on an arc tends to become wider. Therefore, it is possible to determine whether the coupling resin 3 is applied at a predetermined position in the longitudinal direction based on the interval in the arrangement direction of the optical fibers 21 in the image.

In the above embodiment, the light source 11 and the imaging device 12 are disposed to face each other with a roller 37 interposed therebetween. Alternatively, the light source 11 and the imaging device 12 may be disposed to face each other with a roller other than the roller 37 interposed therebetween as long as the roller changes the traveling direction of the optical fiber ribbon 1. For example, as illustrated in FIG. 1, the light source 11 and the imaging device 12 may be disposed to face each other with the roller 38 interposed therebetween.

In the above embodiment, the light source 11 emits light toward the optical fiber ribbon 1 from the direction along the tangent line drawn from the point located at the uppermost position in the region of the side surface 37A of the roller 37 with which the optical fiber ribbon 1 comes into contact. Alternatively, the light source 11 may be configured to emit light toward the optical fiber ribbon 1 from a direction along a tangent line drawn from a point different from the point located at the uppermost position in the region of the side surface 37A of the roller 37 with which the optical fiber ribbon 1 comes into contact.

In the above embodiment, the sub-ribbon 2 is formed by integrating two optical fibers 21. Alternatively, the sub-ribbon 2 may be formed by integrating three or more optical fibers 21.

In the above embodiment, adjacent sub-ribbons 2 are intermittently coupled in the longitudinal direction by the coupling resin 3. Alternatively, the sub-ribbon 2 may not be formed, and adjacent single-core optical fibers 21 may be intermittently coupled to each other in the longitudinal direction by the coupling resin 3.

In the above embodiment, the inspection device 10 is configured to inspect the optical fiber ribbon 1 that travels along an upper-lower direction. Alternatively, the inspection device 10 may be configured to inspect the optical fiber ribbon 1 that travels along a horizontal direction.

In the above embodiment, the camera controller 13 may be configured integrally with a display device and a storage device.

In the above embodiment, the camera controller 13 may be integrated with an intermittent coating controller that controls the operation of the manufacturing device 30 for the optical fiber ribbon 1.

In the above embodiment, the number of the optical fibers 21 forming the optical fiber ribbon 1 is twelve, and the number of the optical fibers 21 is not limited thereto.

In the above embodiment, the inspection by the inspection device 10 is incorporated in a manufacturing process of the optical fiber ribbon 1. However, the inspection by the inspection device 10 may be performed alone. Alternatively, the inspection by the inspection device 10 may be incorporated into a process of performing some processing on the optical fiber ribbon 1, such as a marking process of marking the optical fiber ribbon 1.

What is claimed is:

1. An inspection method for an optical fiber ribbon in which a plurality of optical fibers are arranged in parallel and intermittently coupled in a longitudinal direction by a coupling resin, the inspection method comprising:
emitting light toward the optical fiber ribbon that travels on a roller, from a direction along a tangent line of a surface of the roller with which the optical fiber ribbon comes into contact and parallel to a direction in which the optical fiber ribbon travels, to acquire an image in which the optical fiber ribbon is projected as a shadow, based on light that passed around the optical fiber ribbon;
detecting an interval between the optical fibers, based on the image; and
detecting a position of the coupling resin, based on the image.

2. The inspection method according to claim 1, further comprising:
determining whether the interval between the optical fibers is within a predetermined range;
determining whether the position of the coupling resin is at a predetermined position; and
outputting a determination result of the interval between the optical fibers and the position of the coupling resin.

3. The inspection method according to claim 1,
wherein the roller has a drum shape with a bulging center.

4. The inspection method according to claim 1,
wherein the coupling resin is applied to a first surface of the optical fiber ribbon, and
the optical fiber ribbon is conveyed such that a second surface of the optical fiber ribbon comes into contact with the surface of the roller, the second surface being opposite to the first surface on which the coupling resin is applied.

5. The inspection method according to claim 1,
wherein, in the detecting the interval between the optical fibers, apexes of portions corresponding to the optical fibers are detected in the image to measure an interval between adjacent apexes.

6. An inspection device for an optical fiber ribbon in which a plurality of optical fibers are arranged in parallel and intermittently coupled in a longitudinal direction by a coupling resin, the inspection device comprising:
a light source configured to emit light toward the optical fiber ribbon that travels on a roller, from a direction along a tangent line of a surface of the roller with which the optical fiber ribbon comes into contact and parallel to a direction in which the optical fiber ribbon travels;
an imaging device configured to acquire an image in which the optical fiber ribbon is projected as a shadow, based on light that passed around the optical fiber ribbon; and
a controller configured to detect an interval between the optical fibers and a position of the coupling resin, based on the image.

7. The inspection device according to claim 6,
wherein the controller is configured to:
determine whether the interval between the optical fibers is within a predetermined range and whether the position of the coupling resin is at a predetermined position, and
output a determination result of the interval between the optical fibers and the position of the coupling resin.

8. A manufacturing method for an optical fiber ribbon in which a plurality of optical fibers are arranged in parallel and intermittently coupled in a longitudinal direction by a coupling resin, the manufacturing method comprising:
emitting light toward the optical fiber ribbon that travels on a roller, from a direction along a tangent line of a surface of the roller with which the optical fiber ribbon comes into contact and parallel to a direction in which the optical fiber ribbon travels, to acquire an image in which the optical fiber ribbon is projected as a shadow, based on light that passed around the optical fiber ribbon;
detecting an interval between the optical fibers, based on the image;
detecting a position of the coupling resin, based on the image;
determining whether the interval between the optical fibers is within a predetermined range;
determining whether the position of the coupling resin is at a predetermined position;
outputting a determination result of the interval between the optical fibers and the position of the coupling resin; and
determining quality of the optical fiber ribbon, using the determination result.
